(19) United States
(12) Patent Application Publication
(10) Pub. No.: US 2005/0031830 A1
(43) Pub. Date: Feb. 10, 2005

(54) Weather strip and glass run

(75) Inventors: Kurato Okajima, NIshikasugai-gun (JP); Masanori Aritake, Nishikasugai-gun (JP); Masahiro Mozaki, Nishikasugai-gun (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/885,884

(22) Filed: Jul. 8, 2004

(30) Foreign Application Priority Data
Jul. 11, 2003 (JP) P2003-273437

(51) Int. Cl. B32B 3/04

(52) U.S. Cl. 428/121

(57) ABSTRACT

A glass run includes extruded parts and molded parts connecting the extruded parts together. Each of the extruded parts and the molded parts has a main body portion and seal lips. An interior design lip is formed on an interior side wall portion located on an interior side of a vehicle so as to extend therefrom, while an exterior design lip is formed on an exterior side wall portion located on an exterior side of the vehicle so as to extend therefrom. A film made of an olefin resin material, which is same to the material of each of the molded parts is bonded to the exterior surface of the exterior design lip of each of the extruded parts so as to present the same color and luster as those of the molded parts.

The present application is based on Japanese Patent Application No. 2003-273437, the entire contents of which are incorporated herein by reference.

### BACKGROUND OF THE INVENTION

1. Field of the Invention

The present invention relates to a weather strip of a vehicle and to a glass run for guiding a door glass while sealing between the door glass and a door sash of the vehicle.

2. Description of Related Art

A glass run comprises a main body portion, which consists of a base portion and a pair of side wall portions each extending from the base portion so as to form a substantially-U-shaped cross section, and also comprises a pair of seal lips respectively extending from substantially end parts of both the side wall portions to the inside of the main body portion. Some glass runs each have design lips extending outwardly from the substantially end parts of the side wall portions. The glass run is configured so that the main body portion is attached to a sash provided in a body or a door of a vehicle and that the interior side and the exterior side of glass are sealed by the pair of seal lips.

Generally, the constituent parts of the glass run are classified into extruded parts, each of which extends in the longitudinal direction thereof, and molded parts provided at corner portions thereof. That is, the extruded parts are formed substantially linearly (or elongated) by an extruder. Also, the molded parts are formed by a predetermined mold so that, for example, two extruded parts are connected to each other in a state in which the extruded parts form a predetermined angle. That is, the molded parts correspond to the corner portions.

Hitherto, there has been a related glass run (see Japanese Patent Publication No. JP-A-8-72556) configured so that each of the extruded parts is made of an ethylene-α-olefin-non-conjugated diene copolymer (EPDM (hereunder referred to simply as “EPDM”)) and that each of the molded parts is made of olefin thermoplastic elastomer (TPO (hereunder referred to simply as “TPO”)). Such a technique has a merit that a vulcanizing process or the like is unnecessary for forming the molded parts.

However, in the case of glass runs of the type each having a design lip, because the design lip appears on an appearance surface, there is a fear of occurrence of degradation in the quality of appearance due to differences in color and luster between both the extruded part and the molded part. Especially, in the case that each of the molded parts is made of a material of the kind differing from that of a material of each of the extruded parts as described in Japanese Patent Publication JP-A-08-72556, the aforementioned problems become significant. Additionally, even in the case that both the extruded part and the molded part are made of the same kind of material, the extruded part and the molded part may differ in color and luster from each other due to the differences in molecular weight, viscosity and so on.

Further, the aforementioned problems are inherent not only in such a glass run but all weather strips each having a design surface provided on the exterior side of a vehicle.

### SUMMARY OF THE INVENTION

The invention is accomplished in view of the aforementioned circumstances. Accordingly, an object of the invention is to provide a weather strip and a glass run, which are enabled to prevent the quality of appearance thereof from being degraded due to the difference in color and luster between the molded part and the extruded part.

Hereinafter, means suitable for solving the problems and achieving the object are described by itemization thereof. Incidentally, descriptions of operations and advantages corresponding and peculiar to such means are appended to the description of configuration thereof as needed.

(1) According to an aspect of the invention, there is provided a weather strip (hereunder referred to as a first means of the invention) having extruded parts and molded parts connectedly molded to the extruded parts, and also having a design surface at least on an exterior side of a vehicle. In this weather strip, a film having appearance same to that of the design surface of each of the molded parts is connected to the design surface of an associated one of the extruded parts.

According to the first means of the invention, the film, which presents appearance same to that of the design surface of each of the molded parts, is connected to the exterior design surface of each of the extruded parts of the weather strip. Thus, even in the case that the extruded parts are made of a material, which differs in kind, viscosity and so forth from the material of each of the molded parts, both the extruded part and the molded part present same appearance. Thus, the first means can prevent occurrence of a situation in which the quality of appearance is degraded due to the differences in color, luster and so on. Further, the films are bonded only to the extruded parts without being bonded to the molded parts. Thus, as compared with the case that the films are bonded to all of the molded parts and the extruded parts, time and cost required to bond the films can be reduced Also, in the case that the film is bonded there to when the extruded part is formed, time and effort required to bond the film can be reduced. Incidentally, the “weather strip” referred to herein includes a weather strip of the type having no hollow seal portions, such as a glass run, in addition to the body-side weather strip attached to the body member, and the door-side weather strip attached to the door member.

(2) According to another aspect of the invention, there is provided a weather strip (hereunder referred to as a second means of the invention) having extruded parts and molded parts connectedly molded to the extruded parts, and also having a design surface at least on an exterior side of a vehicle. In this weather strip, a film having color and luster, which are same to those of the design surface of each of the molded parts, is bonded to the design surface of an associated one of the extruded parts.

According to the second means of the invention, the film, which presents appearance same to that of the design surface of each of the molded parts, is bonded to the exterior design surface of each of the extruded parts of the weather strip. Thus, even in the case that the extruded parts are made of a material, which differs in kind, viscosity and so forth from the material of each of the molded parts, both the extruded part and the molded part present same appearance. Thus, the first means can prevent occurrence of a situation in which the quality of appearance is degraded due to the differences in color, luster and so on. Further, the films are bonded only to the extruded parts without being bonded to the molded parts. Thus, as compared with the case that the films are bonded to all of the molded parts and the extruded parts, time and cost required to bond the films can be reduced. Also, in the case that the film is bonded thereto when the extruded part is formed, time and effort required to bond the film can be reduced.

(3) In an embodiment (hereunder referred to as a third means of the invention) of the first or second means of the invention, the film is bonded thereto when the extruded parts are extruded.

According to the third means of the invention, the film is bonded thereto at the extrusion-forming of the extruded parts. This eliminates the necessity for providing another bonding process. Thus, time required to bond the film thereto can be reduced. Moreover, effort required to bond the film thereto can be reduced. Additionally, a space required for manufacturing weather strips can be decreased Furthermore, equipment therefore can be simplified.

(4) According to still another aspect of the invention, there is provided a glass run (hereunder referred to as a fourth means of the invention) including extruded parts and molded parts connectedly molded to the extruded parts. Each of the molded parts has a cross-sectionally substantially U-shaped body portion, which comprises a base portion, an exterior side wall portion and an interior side wall, and also has seal lips, which inwardly extend from both the side wall portions, and an exterior design lip formed in such a way as to extend at least from the exterior side wall portion to an exterior side of the vehicle. In this glass run, a film having color and luster, which are same to those of an exterior surface of the exterior design lip of each of the molded parts is bonded to an exterior surface of the exterior design lip of each of the extruded parts.

According to the fourth means of the invention, the film, which presents appearance same to that of the design surface of each of the molded parts, is bonded to the exterior design surface of each of the extruded parts of the glass run. Thus, even in the case that the extruded parts are made of a material, which differs in kind, viscosity and so forth from the material of each of the molded parts, both the extruded part and the molded part present same appearance. Thus, the first means can prevent occurrence of a situation in which the quality of appearance is degraded due to the differences in color, luster and so on. Further, the films are bonded only to the extruded parts without being bonded to the molded parts. Thus, as compared with the case that the films are bonded to all of the molded parts and the extruded parts, time and cost required to bond the films can be reduced. Also, in the case that the film is bonded thereto when the extruded part is formed, time and effort required to bond the film can be reduced.

(5) In an embodiment (hereunder referred to as a fifth means of the invention) of the fourth means of the invention, each of the molded parts is made of TPO. At least one of the extruded parts is made of EPDM. The film is made of an olefin resin material.

According to the fifth means of the invention, the molded parts are made of TPO. Thus, at the injection-molding, a vulcanizing process is unnecessary. Therefore, the number of man hours needed for molding can be reduced, while production efficiency can be enhanced. On the other hand, at least one of the extruded part is made of EPDM, so that the differences in color and luster between the extruded part and the molded part are concerned. However, regarding this, according to the fifth means of the invention, the film made of an olefin resin material is bonded to the exterior design lip of such an extruded part, so that the extruded part presents color and luster, which are same to those of the molded part. Consequently, the aforementioned advantages in suppressing the degradation in the quality of appearance are more reliably achieved. Also, elasticity of the seal lip of the extruded part made of EPDM can be enhanced. Moreover, the stability in attaching the glass run to the sash of the door can be enhanced.

(6) In an embodiment (hereunder referred to as a sixth means of the invention) of the fifth means of the invention, one of the extruded parts, which corresponds to a top side portion of the glass run, is made of EPDM. Each of the extruded parts, which respectively correspond to front and rear longitudinal side portions of the glass run, is made of TPO.

According to the sixth means of the invention, the following operations and advantages can be achieved, in addition to those of the fifth means. That is, the extruded parts, which correspond to the longitudinal side portions, and the molded parts are made of TPO. Thus, the vulcanizing process is unnecessary for molding these molding portions correspond to the longitudinal side portions. Therefore, the number of man hours needed for molding can be reduced, while production efficiency can be enhanced. Further, the extruded part corresponding to the top side portion is made of EPDM that excels in shape compliance. Consequently, the sixth means can effectively suppress occurrence of problems, such as curling deformation, when a door glass is closed.

(7) In an embodiment (hereunder referred to as a seventh means of the invention) of one of the fourth to sixth means of the invention, the film is integrally bonded thereto in a manufacturing process of extrusion-forming the extruded parts.

According to the seventh means of the invention, the film can be bonded thereto in the processing process of extrusion-forming of the extruded part. Thus, there is no need for providing another bonding process. Consequently, time required to bond the film thereto can be reduced. Moreover, a manufacturing space can be decreased. Also, equipment for manufacturing the glass run can be simplified. Especially, in the case of the extruded part made of TPO, the film can be simultaneously extruded by using one extrusion die. Additionally, the film can be stuck thereto immediately after the extrusion of the extruded parts.

(8) In an embodiment (hereunder referred to as an eighth means of the invention) of one of the fifth or sixth means of the invention, the film is integrally bonded thereto by heat-welding after undergoing a vulcanizing step in a manufacturing process of extrusion-forming the extruded parts made of EPDM.

According to the eighth means of the invention, the film is bonded by heat-welding after undergoing the vulcanizing process. Thus, there is no additional necessity for adhesives. Also, in the subsequent injection-molding process, the molded parts are made of TPO. Thus, there is no need for setting the temperature of the molding apparatus at a high value. Consequently, the eighth means prevents occurrence of a situation in which the peeling-off of the heat-welded film is caused.

### BRIEF DESCRIPTION OF THE DRAWINGS

FIG. 1 is a cross-sectional view illustrating an extruded part of a glass run according to an embodiment, which is taken on line I-I of FIG. 2;

FIG. 2 is a schematic front view illustrating a schematic configuration of the glass run; and

FIG. 3 is a cross-sectional view illustrating a molded part of the glass run, which is taken on line III-III of FIG. 2.

### DETAILED DESCRIPTION OF THE PREFERRED EMBODIMENTS

Hereinafter, an embodiment of the invention is described by referring to the accompanying drawings.

In an automobile having doors, a glass run 1, which is one of weather strips, is attached to a part corresponding to the outer periphery of a window glass opening each of the doors. More particularly, a sash is provided along the shape of the outer periphery of each of the doors. The glass run 1 according to this embodiment is attached to the inner periphery of the sash.

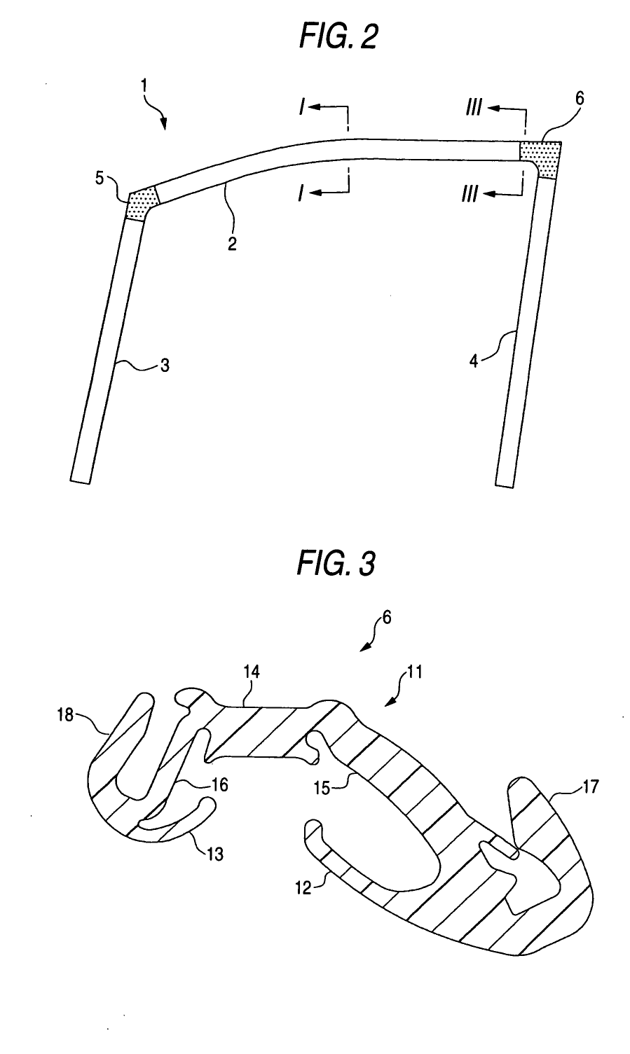

As shown in FIG. 2, the constituent parts of the glass run 1 are classified into an extruded part 2 corresponding to the top side portion thereof, extruded parts 3, 4, which respectively correspond to front and rear longitudinal side portions thereof, and molded parts 5, 6. (indicated by dotted patterns in FIG. 2) for connecting the end parts of the extruded parts 2, 3, 4, as viewed in this figure. The extruded parts 2 to 4 are formed substantially linearly (or elongated) by an extruder (not shown). Further, the molded parts 5 and 6 are connectedly molded by a molding apparatus (not shown) so that the two extruded parts 2, 3 and 2, 4 are connected to each other in such away as to form a predetermined angle. In this embodiment, the molded parts 5 and 6 correspond to corner portions, respectively.

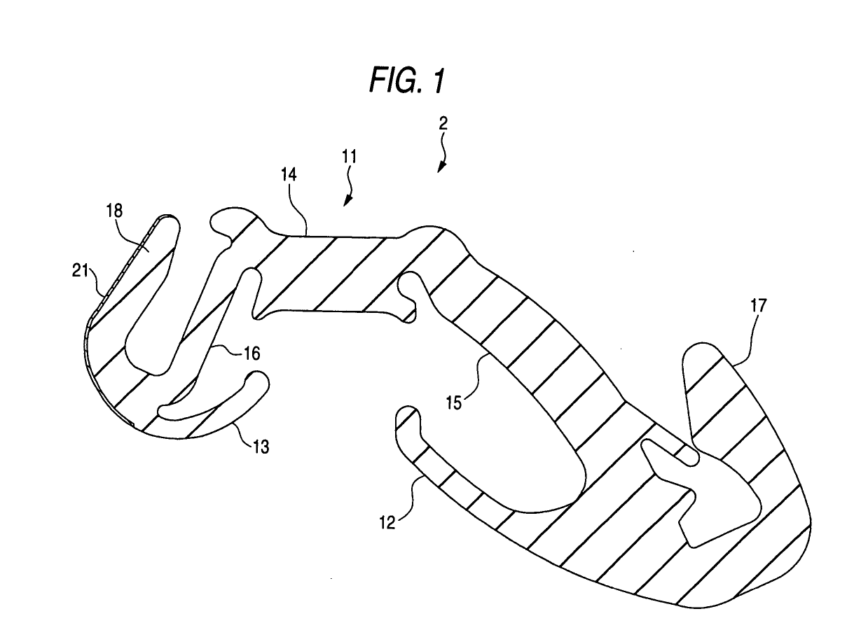

FIG. 3 is a cross-sectional view illustrating the molded part 6 of the glass run, which is taken on line III-III of FIG. 2. FIG. 1 is a cross-sectional view illustrating the extruded part 2 of a glass run according to an embodiment, which is taken on line I-I of FIG. 2. As shown in these figures, each of the extruded parts 2 to 4 and the molded parts 5 and 6 has a body portion 11 and a pair of seal lips 12 and 13. The body portion 11 consists of a base portion 14, which is fitted into the sash, and an interior side wall portion 15 and an exterior side wall portion 16, which extend from the base portion 14. Further, each of the seal lips 12 and 13 extends from an associated one of substantially ends of both the side wall portion 15 and 16 to the inside of the body portion 11 (in the direction of the base portion 14). Consequently, the interior side and the exterior side of glass (not shown) are sealed.

Also, in this embodiment, an interior design lip 17 extending outwardly (or to the interior side of the vehicle) from the interior side wall portion 15. Moreover, an exterior design lip 18 extending outwardly (or to the exterior side of the vehicle) from the exterior side wall portion 16 is formed.

In this embodiment, the extruded part 2 corresponding to the top side portion is made of EPDM. Further, each of the extruded parts 3, 4 respectively corresponding to the front and rear longitudinal side portions is made of TPO. Incidentally, the TPO constituting the molded parts 5, 6 some what differs in molecular weight, viscosity and so forth from the TPO constituting the extruded parts 3, 4, which respectively correspond to the longitudinal side portions, due to the difference therebetween in the molding method.

Moreover, in this embodiment, a film 21 made of an olefin resin material is bonded to an exterior surface of the exterior design lip 1 of each of the extruded parts 2, 3, 4. A material equivalent or analogous to the material of each of the molded parts 5, 6 is used as the material of this film 21 so as to present the same color and luster as those of the molded parts 5, 6. Incidentally, this olefin resin material conceptually includes TPO.

In this embodiment, a device for heat-welding the film 21 is provided at the downstream side of a vulcanizing apparatus. When the extrusion-forming of the extruded part 2 made of EPDM is performed, the film 21 is heat-welded to the exterior surface of the exterior design lip 18 after undergoing extrusion and vulcanizing processes. On the other hand, a mechanism for feeding the film 21 is juxtaposed with an extruder for extrusion-forming TPO. When the extrusion-forming of the extruded parts 3, 4 made of TPO is performed, the film 21 is heat-welded to the exterior surface of the exterior design lip 18, substantially simultaneously with the extrusion of TPO. Incidentally, in this case, simultaneous extrusion-forming can be performed by supplying TPO and a film material to one extrusion die.

Next, operations and advantages of this embodiment configured in the aforementioned manner are described hereinbelow.

In this embodiment, the film 21, which presents the same color and luster as those of the exterior surface of the exterior design lip 18 of each of the molded parts 5, 6 of the glass run 1, is bonded to the exterior surface of the exterior design lip 18 of each of the extruded parts 2, 3, 4 thereof. Thus, even in the case that the extruded part 2 is made of a material differing from the material of each of the molded parts 5, 6, and that each of the extruded parts 3, 4 is made of a material differing in viscosity and so on from the material of each of the molded parts 5, 6, all of the molded parts and the extruded parts present same appearance. Consequently, this embodiment can prevent occurrence of a situation in which the quality of appearance from being degraded due to the difference in color, luster and so on there among.

Additionally, the film 21 is not bonded to the molded parts 5, 6 but bonded only to the extruded parts 2 to 4. Thus, as compared with the case that the films 21 are bonded to all of the molded parts and the extruded parts of the glass run 1, time, cost, and so forth required to such connection can be reduced.

Moreover, in this embodiment, the film 21 is bonded thereto when each of the extruded parts 2 to 4 is formed. Thus, there is no necessity for providing an additional bonding process. Consequently, time and effort required to bond the film can be reduced. Moreover, a space required to manufacture the glass run can be reduced. Also, equipment for manufacturing the glass run can be simplified.

Additionally, the extruded parts 3, 4, which correspond to the longitudinal side portions, and the molded parts 5, 6 are made of TPO. Thus, the vulcanizing process is unnecessary for molding these molding portions. Therefore, the number of man hours needed for molding can be reduced, while production efficiency can be enhanced. On the other hand, the extruded part 2 corresponding to the top side portion is made of EPDM that excels in shape compliance. Consequently, this embodiment can effectively suppress occurrence of problems, such as curling deformation, when a door glass is closed.

Also, the molded parts 5, 6 are made of TPO. There is no necessity for setting the temperature of the molding apparatus at a high level. Thus, this embodiment can more surely prevent occurrence of peeling-off of the film 21 heat-welded when the extruded parts 2 to 4 are formed.

Incidentally, the invention is not limited to the matters described in the description of the aforementioned embodiment and may be carried out as follows. Needless to say, other alterations and modifications exemplified hereinbelow may be made.

(a) Although the configuration of the interior design lip 17 has not been described in the foregoing description of embodiment, for example, the following configuration thereof may be employed. That is, in recent years, there have been demands for coloring the interior design lip 17 in such a way as to be matched with decorative color at the interior-side of the vehicle. In this case, the molded parts 5, 6 are molded by two-color molding so as to color the interior design lip 17. The interior lip 17 of each of the extruded parts 2 to 4 is configured so that a film, whose color is matched with the color of the interior design lip 17 of each of the molded parts, is attached thereto. In this case, the film 21 may be bonded to the exterior surface of the exterior design lip 18 so that the color and luster thereof are matched with those of a part other than the interior design lip 17 of each of the molded parts 5, 6. In short, the film may be bonded thereto by allowing various variations in the shape of a cross-section of the glass run 1.

(b) Although the invention is embodied as the glass run 1 substantially consisting of the three extruded parts 2 to 4 and the two molded parts 5, 6 in the case of the aforementioned embodiment, the number of the molding portions are not limited thereto. Therefore, the glass run may be composed of two extruded parts and one molded part connecting these extruded parts. Alternatively, the glass run may be composed of one extruded part and one molded part connected to at least one end of the extruded part.

(c) Although the extruded part 2 is made of EPDM in the aforementioned embodiment, the extruded part 2 may be made of another material, such as TPO. Further, although the extruded parts 3, 4 corresponding to the longitudinal side portions are made of TPO, these extruded parts 3, 4 may be made of another material, such as EPDM.

(d) The material of the film 21 is not necessarily limited to the same material as that of each of the molded parts 5, 6. As long as the film 21 can present same appearance, the material of the film 21 is not limited to a specific material.

(e) Although the invention is embodied as the glass run provided with both the interior design lip 17 and the exterior design lip 18 in the case of the aforementioned embodiment, the invention can be applied to a glass run in which at least one of these lips is omitted. In short, it is sufficient that a film enabled to present appearance same to that of the design surface of each of the molded parts is bonded to an externally visible extrusion-forming part.

(f) Although the invention is embodied as the glass run 1 serving as a weather strip in the case of the aforementioned embodiment, the invention may be embodied as another weather strip other than the glass run, for instance, a body-side weather strip attached to a body side, and a door weather strip attached to a door side.

(g) Further, in the invention, the film may be formed longer than the extruded part in the extrusion forming. The injection-molding may be conducted while the spared part of the film is set on a cavity face, so that the film is bonded to a surface of the molded part. By bonding the film in such the manner, the film is exposed on the molded part. Therefore, a better appearance may be obtained.

1. A weather strip comprising:
an extruded part and a molded part connecting to said extruded part, and
a design surface formed along said extruded part and said molded part at least on an exterior side of a vehicle,
wherein a film is provided on said extruded part for forming said design surface, and
said film has a surface appearance same to said design surface formed on said molded part.

2. A weather strip comprising:
an extruded part and a molded part connecting to said extruded part, and
a design surface formed along said extruded part and said molded part at least on an exterior side of a vehicle,
wherein a film is provided on said extruded part for forming said design surface, and
said film has a color and a luster, which are same to those of the design surface formed on said molded part.

3. A weather strip according to claim 1, wherein said film is provided on said extruded part by extrusion.

4. A glass run comprising:
an extruded part and a molded part connecting to said extruded part, each of extruded part and molded part is provided with:
a main body portion formed with a substantially U-shaped cross-section constituted by a base portion, an exterior side wall portion and an interior side wall portion,
seal lips inwardly extending from both of said interior and exterior side wall portions, and
an exterior design lip extending from said exterior side wall portion to an exterior side of a vehicle,
wherein a film is provided on said exterior design lip in said extruded part,
said film has a color and a luster same to those of an exterior surface of said exterior design lip of said molded part.

5. A glass run according to claim 4, wherein said molded part is made of a first TPO material;
a plurality of said extruded parts are provided, and at least one of said extruded parts is made of an EPDM material; and
said film is made of an olefin resin material.

6. A glass run according to claim 5, wherein the extruded part which corresponds to a top side portion of said glass run, is made of the EPDM material; and
the extruded parts which correspond to a front longitudinal side portion and a rear longitudinal side portion of said glass run, are made of a second TPO material.

7. The glass run according to claim 4, wherein said film is integrally provided on said extruded part by extrusion in a process forming said extruded part.

8. The glass run according to claim 5, wherein said film is integrally provided on said extruded part by heat-welding after performing a vulcanizing step in a process forming said extruded part by extrusion.
